(19) United States
(12) Patent Application Publication
(10) Pub. No.: US 2008/0197968 A1
(43) Pub. Date: Aug. 21, 2008

(54) Power Stand-Alone Electronic System

(75) Inventor: Frank Schmidt, Altkirchen (DE)

Correspondence Address: COHEN, PONTANI, LIEBERMAN & PAVANE LLP, 551 FIFTH AVENUE, SUITE 1210, NEW YORK, NY, 10176, US

(73) Assignee: EnOcean GmbH, Oberhaching (DE)

(21) Appl. No.: 11/659,602

(22) PCT Filed: Jul. 28, 2005
(86) PCT No.: PCT/DE05/01335

§ 371 Date: Oct. 29, 2007

(30) Foreign Application Priority Data
Aug. 3, 2004 (DE) 10 2004 037 587.9

(51) Int. Cl. G05B 19/00; G07C 9/00; E05B 47/00

(52) U.S. Cl. 340/5.2

(57) ABSTRACT

A self-powered electronic system for checking the authorization of individual persons to operate a device, comprising a first subsystem (1), a second subsystem (2), and an operating unit (3) that is assigned to the device (4) and which, when activated by a person (P), initiates checking of the individual person's authorization, where both subsystems (1, 2) communicate with one another bidirectionally, and where this communication takes place through electrically initialized signals.

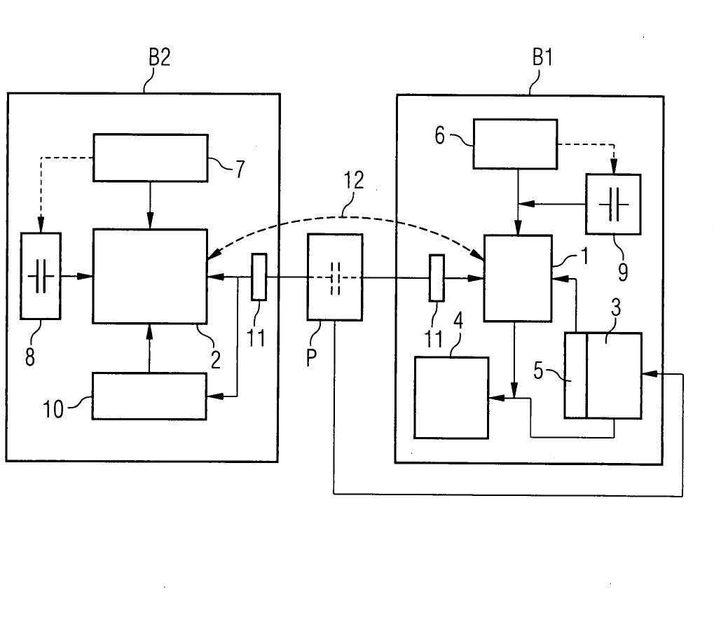

The invention concerns a self-powered electronic system for checking the authorization of individual persons for the operation of a device.

Systems of various types for checking authorizations are known. Systems are, for instance, known that operate in the manner of transponder systems. If a person carrying a mobile transponder enters the operating range of a transmitting and receiving station that communicates with the transponder, the station reads the data content, the identification data, of the transponder and, according to the authorizations that are associated with the identification data, grants access to the locked area.

Other systems are known, for instance, which, when some person touches a fingerprint sensor, checks the fingerprint of that person, comparing it with stored data, for instance with fingerprints, on the basis of which they initiate or block a further action. Systems are also known that, by means of an iris scanner, examine a person's iris and compare it with stored data, on the basis of which they may, when appropriate, grant access to a protected area.

Problems are associated with systems of the types mentioned above. In particular, the biometric systems suffer from the problem that the available sensor technology does not operate with the desired reliability. The soiling of fingerprint sensors and, of course, of optical or optoelectronic iris readers, cannot be prevented, and inevitably results in errors.

A problem associated with the transponder systems mentioned above is that the distance between the person who is carrying the mobile transponder and the receiving and transmitting unit has a direct effect on the quality of transmission, and therefore on the correct operation of the system. It is not, for instance, possible to exclude the possibility of a fault arising due to a second person being located within this region.

In addition, the systems mentioned above require a power supply to be wired to the fixed station in order both to maintain radio communication with the mobile transponder and to supply the transponder with the necessary power.

Yet another disadvantage is associated with the wired power supply to the fixed station in the systems mentioned above. It is either not possible, or only possible at considerable expense, to install a system of this type at a location that, for instance, is remote from a wired power supply. Fitting systems of this type to areas that are not bound to a specific location, such as vehicles, can only be done if an uninterrupted power supply can be expected at the vehicle. Since the supply of power to stationary vehicles is provided by electrochemical accumulators that necessarily have a limited life, it cannot be assumed that an uninterrupted supply of power will always be available. In addition, a system of this type draws a not inconsiderable quantity of electrical energy from the accumulators even when stationary, as a result of which failure of such a system must be expected merely as a result of the vehicle standing idle for a long period. Systems of this type are therefore either unable, or only able to a limited degree, to function reliably and over long periods in such locations.

It is therefore the purpose of the invention to provide a system for checking the authorization of individual persons, and which is also capable of operation at locations whose supply of electrical power is not continuously assured, for instance at locations where no supply of electrical power is available.

This task is fulfilled by the methods described in claim 1, and these are advantageously explained further in the methods described in the subsidiary patent claims.

A self-powered electronic system for checking the authorization of individual persons to operate a device is described, comprising a first subsystem, a second subsystem and an operating unit that is assigned to the device, and which, when activated, initiates checking of the individual person's authorization.

The two subsystems communicate bidirectionally, and the communication between the two subsystems takes place through electrically excited signals. It is arranged that the communication between the first and second subsystems only begins when a person activates the operating unit. Because the operating unit is assigned to the device for whose operation the authorization is to be checked, the distance between the person and the device is already appropriate. It results naturally from the length of the arms of the person concerned. This means that persons whose distance from the device is greater than arms' length are thereby not in a position to activate the operating unit. This favorably excludes the possibility that a request for authorization is triggered in error, also thereby preventing unauthorized persons from being granted authorization as a result, for instance, merely of the simultaneous presence of an authorized person.

It is advantageous to locate the first subsystem physically close to the device whose operation is to be secured, and to have the second subsystem carried by the authorized person as a mobile subsystem. As a consequence of the contact of the person with the operating unit, and the naturally arising contact between the person carrying the mobile, second subsystem, the favorable option arises of transmitting the electrically excited signals through the body of the person. This is then favorably implemented in a capacitative form, as a result of which the method of transmission can be considered highly immune to interference. Radio transmission of the signals is a further possibility. In the case of radio transmission, however, other methods that are not part of this invention must be taken in order to ensure that the transmission of the signals is immune to interference.

The power supply to the first subsystem can, for instance, in a favorable form of implementation, be provided through an energy converter attached, positively and adhesively, to the operating unit. In this case the option presents itself of using energy converters such as are known from self-powered radio switches. These permit operation with an independent supply of energy, and so generate the energy for the first subsystem at the moment when the operating unit is activated.

With the generation of the energy for the first subsystem through activation of the operating unit, the first subsystem is supplied with energy and commences operation. The first subsystem continues to operate until the generated energy has been consumed. When the first subsystem begins to operate, it sends a signal to the second subsystem. The second subsystem returns its identification data as a response signal.

A check is then carried out in the first subsystem to determine whether the identification data that has been transmitted by the second subsystem satisfies specified enabling criteria. The first subsystem may, for instance, compare the identification data with stored data, granting authorization to operate the device if there is agreement. Electromechanical energy converters, pyroelectric or electromagnetic energy converters, magnetostrictive energy converters or a combination of such energy converters present themselves as appropriate energy converters for this purpose. In essence, it follows that any energy converter capable of converting mechanical energy to electrical energy may be used.

If the force is applied to the operating unit, then part of this force acts on the energy converter. The energy converter converts the energy applied in this way into electrical energy, and this in turn generates an electrical signal in the first subsystem that is passed on to the second subsystem. The response signal from the second subsystem then makes it possible, in the event of authorization and/or agreement of the identification data with the stored data, for the action associated with the operating units to be initiated or executed.

A variety of different operating units may, for instance, be envisaged here. Only a small number of examples are mentioned below, and these can only represent a small extract from the wide scope of possible applications. A door handle, for instance, may be mentioned, which must be moved through the application of force. A pressure switch provides another example, containing additional functions, or a push switch that is also capable of initiating further actions. The switches of data-processing equipment may also be mentioned, and much more. Any operating unit whose method of use permits a portion of the energy applied when it is activated to be diverted and converted into electrical energy in a converter is suitable.

Depending on the nature of the operating unit, the associated energy converter may adopt a larger or smaller form. The quantity of electrical energy which can be generated in this energy conversion process is therefore not always equally great, and may therefore not always be sufficient to perform the whole of the procedure described above. In this case, it is favorable for a second energy converter to be associated with the first subsystem, supplying this additionally or alternatively with electrical energy. This second energy converter draws its energy from the ambient energy surrounding the first subsystem. This may, for instance, include light or heat that can be converted to electrical energy by means of solar cells, pyroelectric energy converters or by firmer-electric energy converters.

Excess energy that may be made available by the second energy converter is to be retained temporarily in a capacitative or electrochemical energy store, reserving it for the eventuality in which an adequate quantity of convertible energy is not available in the environment.

The mobile subsystem favorably incorporates its own power supply, since a supply of power through an electromagnetic field, as is used in transponder systems, is not advantageous in this case. The independent power supply of the second subsystem can consist of a capacitative or electrochemical energy store. It is favorable if the second subsystem has an energy converter that can convert energy surrounding the second subsystem into electrical energy. In this case again, an electrochemical or capacitative energy store for the temporary storage of excess energy is advantageous. The implementation of such an energy converter and its associated store are correspondingly smaller, as they must find room on a mobile subsystem that is carried, for instance, in a pocket in the person's clothing or directly on the person.

Since the physical form of the second subsystem is relatively small, it is of particular advantage if the energy made available to the second subsystem is used as sparingly or economically as possible. For this reason it is favorable if the second subsystem is put into a state of minimum energy consumption when it is idle, and for it to be switched into an operating mode by a so-called wake-up signal that is transmitted by the first subsystem and which causes the second subsystem to transmit its identification data. The method of transmitting the information through the body of the person also involves significantly less expenditure of energy than the transmission of comparable information over the same distance by a radio signal.

In order to switch the second subsystem out of its idling state into the operating mode, a wake-up device is provided and associated with the second subsystem. The wake-up device is activated by an electrically excited signal from the first subsystem. This electrically excited signal is initiated through operation of the device.

In the operating state, the second subsystem transmits at least one signal containing its identification data to the first subsystem. The bearer of the second subsystem is therefore identifiable to the first subsystem. The first subsystem checks the authorization by comparing the information with previously stored information. If authorizations to operate the device are assigned to this information, the first subsystem enables activation of the device, or triggers some subsequent action.

It is favorable if the communication between the two subsystems is protected against unauthorized modification or interference through an encryption technique.

In what follows, the invention is explained in more detail with the aid of a particular example and with the help of a diagram.

The FIGURE provides a diagrammatic illustration of a self-powered electronic system for checking the individual personal authorizations for the operation of the device in accordance with the principle of the present invention.

The diagram shows a first subsystem 1 and a second subsystem 2. The two subsystems are located in physically separated regions B1 and B2. The first subsystem is assigned to physical region B1, corresponding to the region that is to be secured. The first subsystem 1 is associated with an operating unit 3, provided for operation of the device 4. The operating unit 3 also has an energy converter 5 that converts a proportion of the force applied to activate the operating unit into electrical energy.

This electrical energy is supplied to the first subsystem, setting the first subsystem into operation. The force exercised for the purposes of operation is applied by a person P who wants to operate the device 4. The person P carries the second subsystem 2. After the first subsystem 1 has begun operation, the first subsystem 1 sends a signal to the second subsystem 2. The second subsystem 2 replies to this signal by transmitting its identification information. Bidirectional communication has therefore taken place, and is then completed. This bidirectional communication may also be repeated in order to increase the security of transmission, at least as often as is necessary for one of the two subsystems to be able to confirm error-free transmission. Transmission procedures that are not part of this invention are known for this process.

In the first subsystem 1 the identification information transmitted by the second subsystem 2 is compared with known data. The first subsystem 1 enables operation of the device 4. This can be done in a variety of ways. The following list therefore only provides examples that represent a wide range of possible options. It is, for example, possible for
the enabling to be provided through mechanical unlatching, where a locking bar unlatches the operating unit, for instance a door handle, which can then be moved further, or a push-button that can be pushed further down.
a command that is stored in the operating unit to be passed on electrically, as a result of which the device can be operated.
in the event that the operating unit is a radio switch, for a radio signal to be transmitted only after the enable has been granted, thus allowing the device to be operated, for instance for lighting equipment to be activated.

In the first example of implementation, a second energy converter 6 is associated with the first subsystem, and this converts energy from the environment of the first subsystem into electrical energy. This may, for instance, be thermal energy that is converted into electrical energy by means of a thermocouple or a pyroelectric converter, or it may be solar energy converted into electrical energy by a solar cell, or it may be wind energy converted by means of an electromagnetic converter, or may be some other form of kinetic energy that can also be converted into electrical energy by means of an electromagnetic or piezo-electric converter.

A mobile energy converter 7, which is also capable of converting thermal energy, solar energy or kinetic energy present in the environment of the second subsystem into electrical energy is associated with the second subsystem.

Here again forms of energy such as thermal energy using thermocouples or pyroelectric converters, solar energy or kinetic energy can be converted into electrical energy using the appropriate conversion systems mentioned above. Surplus energy that is made available by the mobile energy converter 7 is favorably stored in the mobile energy store which, again, is associated with the second subsystem. It is thus ensured that, even at times where no convertible energy is available in the environment of the second subsystem, adequate electrical energy is available so that after reception of a wake-up signal, a short signal containing the identification data can be transmitted. For this reason, an energy store of this or a similar sort 9 forms part of the first subsystem 1.

The second subsystem 2 incorporates a wake-up device 10; this, excited by a signal from the first subsystem, switches the second subsystem from its idle state into an operating mode. The idle state is favorably a state in which the energy consumption is extremely low. This is of particular importance for the second subsystem, whose physical extent must be considered small. In the above-mentioned idle state, only the wake-up device 10 is supplied with electrical power.

Both subsystems are equipped with corresponding methods (11) of encryption. This protects the transmission of the information from interference, unauthorized modification or eavesdropping. The transmission of the information does not have to be implemented only through capacitative coupling through the body of the person P, but alternatively may be implemented through a radio signal 12.

An example of an application will provide further clarification to the advantages of the present invention, even at locations where adequate electrical energy is in fact available. It is, for example, favorably possible to fit the system in accordance with the invention described above to a button in a lift 3, where the button provides access to a certain secure region B1 by travelling to a particular floor of the building that is only to be accessible to a specially authorized group of persons.

A person who presses the lift button 3 therefore does not initiate movement of the lift 4; instead, pressing lift button 3 unnoticeably provides energy to energy converter 5 and sends a signal to the first subsystem 1. This signal is transmitted through the body of the person P to the second subsystem 2. The surface of the lift button 3 is designed in such a way that the signal can be transmitted to the body of the person P.

If a corresponding second subsystem 2 is not found on the person P, pressing the lift button 3 will have no further consequences, and the lift 4 will not move. If a second subsystem 2 is present on person P, it will transmit the identification data to the first subsystem 1 after it receives the signal from the first subsystem 1. The first subsystem 1 compares the identification data with the known data. If the subsystem 1 determines that the data are in agreement, and therefore determines that there is authorization for access to the floor concerned, that is to region 1, the lift 4 will move. This will all happen without the person P experiencing any noticeable delay in the requested action.

### List of Reference Numbers

1 First subsystem
2 Second subsystem
B1 Region of the first subsystem
B2 Region of the second subsystem
3 Operating unit
4 Device
5 Energy converter
6 Second energy converter
7 Mobile energy converter
8 Mobile energy store
9 Energy store
10 Wake-up device
11 Encryption method
12 Radio signal
P Person

1. A self-powered electronic system for checking the authorization of individual persons to operate a device, comprising:
a first subsystem;
a second subsystem;
an operating unit that is assigned to the device and which, when operated by a person, initiates checking of the individual person's authorization,
wherein said first and second subsystems communicate with one another bidirectionally through electrically initialized signals, and
wherein the electrically initialized signals are transmitted through the body of the person by means of capacitive coupling.

2. The self-powered system in accordance with claim 1,
wherein
the first subsystem is located physically close to the device, and the second subsystem is portable and is separate from the first subsystem, being carried, for instance, by the person.

3. (canceled)

4. The self-powered system in accordance with claim 1,
wherein
the supply to the first subsystem of electrical energy by means of an energy converter positively or adhesively bonded to the operating unit, and wherein a proportion of the activation energy is applied in order to operate the operating unit is diverted to the energy converter.

5. The self-powered system in accordance with claim 4,
wherein
the energy converter is an electromechanical energy converter.

6. The self-powered system in accordance with claim 1,
wherein
the supply of the first subsystem with electrical energy is provided by at least one second energy converter that converts convertible energy in the environment of the first subsystem into electrical energy.

7. The self-powered system in accordance with claim 6,
wherein
the second energy converter is one from the group consisting of a solar energy converters, a thermoelectric energy converters, a pyroelectric energy converter and a converter for electromagnetic radiation.

8. The self-powered system in accordance with claim 1,
wherein
the supply of the second subsystem with electrical energy is provided by a mobile energy converter that converts convertible energy in the environment of the second subsystem into electrical energy.

9. The self-powered system in accordance with claim 8,
wherein
the mobile energy converter is an electromagnetic energy converter and/or a piezo electric energy converter and/or a magnetostrictive energy converter and/or a thermoelectric energy converter and/or a solar energy converter.

10. The self-powered system in accordance with claim 1,
wherein
the supply of the second subsystem with electrical energy is provided by a mobile capacitative or electrochemical energy store.

11. The self-powered system in accordance with claim 10,
wherein
the mobile energy store stores surplus electrical energy generated by the mobile energy converter, and supplies it when needed to the second subsystem.

12. The self-powered system in accordance with claim 1,
wherein
a wake-up device is assigned to the second subsystem, where the wake-up device can be activated by an electrically excited signal from the first subsystem, and switches the second subsystem out of an idle state in which the energy consumption is minimized into an operating state.

13. The self-powered system in accordance with claim 1,
wherein
the second subsystem when in the operating state sends at least one information-carrying signal to the first subsystem that identifies the bearer of the second subsystem, and where the first subsystem performs a check on the authorization by comparing the information with known information, enabling operation of the device if such authorization is assigned to the information.

14. The self-powered system in accordance with claim 1,
wherein
the communication between the first subsystem and the second subsystem is protected by an encryption method.

15. The self-powered system in accordance with claim 5, wherein the electromechanical energy converter is one from the group consisting of a piezo electric energy converter, an electromagnetic energy converter and a magnetostrictive energy converter.
